(19) United States
(12) Patent Application Publication
(10) Pub. No.: US 2025/0168501 A1
(43) Pub. Date: May 22, 2025

(54) System and method for detecting a bright spot

(71) Applicant: NEW IMAGING TECHNOLOGIES, VERRIERES LE BUISSON (FR)

(72) Inventors: Vincent NOGUIER, VERRIERES LE BUISSON (FR); Martin SCHWEITZER-CHAPUT, VERRIERES LE BUISSON (FR)

(21) Appl. No.: 18/904,779

(22) Filed: Oct. 2, 2024

(30) Foreign Application Priority Data
Oct. 2, 2023 (FR) 2310507

(51) Int. Cl. H04N 23/60; H04N 23/56; H04N 23/73

(52) U.S. Cl. CPC H04N 23/665; H04N 23/56; H04N 23/73

(57) ABSTRACT

A method is provided for detecting a light spot (T) formed by a laser pulse delivered by a laser source (10) on a target surface (S), the target surface being situated in an environment delivering a substantially static luminous flux. The method includes at least one sensor (30) with pixels operating in photovoltaic mode observing the surface, and synchronizing the end of the exposure, to within a delay, with the laser pulse, leading to a response of the sensor which is substantially linear to the pulse and logarithmic with regard to the substantially static luminous flux.

### RELATED APPLICATION

This application claims the benefit of priority from French Patent Application No. 23 10507, filed on Oct. 2, 2023, the entirety of which is incorporated by reference.

### TECHNICAL FIELD

The present invention relates to detecting a light spot within an environment generating a static luminous flux which is relatively large relative to that due to said spot.

### PRIOR ART

Many applications make it necessary to be able to view, using an optical sensor, a light spot produced by a laser pulse striking a surface.

CMOS optical sensors of the CTIA (capacitive trans-inductance amplifier) type notably comprise a backward-biased photodiode used in photoconductor mode.

The applicant company has developed optical sensors the pixels of which comprise a forward-biased photodiode used in photovoltaic mode.

Examples of such sensors are described in the patent applications WO2002059974A1, WO2009027449A1 and WO2010103464A1.

The advantage of these sensors is to be able to intrinsically have a logarithmic response and not to saturate before a large static luminous flux originating from the scene observed.

In the dark or in a dark environment it is easy to view the spot produced by a laser pulse of short duration in a scene; however, in a relatively luminous environment, for example in the day, it is the opposite. This is because the photon flux corresponding to the laser feedback in the image is relatively small with respect to that originating from the whole of the scene.

Because of this, most solutions aiming to detect a laser spot incorporate a function of detecting the laser pulse within the pixels, but this notably has the drawback of producing a binary result and of not obtaining a faithful image of the light spot in its environment.

### DISCLOSURE OF THE INVENTION

Consequently, there is a need to benefit from a technical solution which makes it possible to more faithfully and directly view a light spot corresponding to a laser pulse within a scene, even when the static luminous flux originating from the scene is relatively large, such as in broad daylight.

### SUMMARY OF THE INVENTION

The invention meets this need by proposing a method for detecting a light spot formed by a laser pulse on a target surface, delivered by a laser source, the target surface being situated in an environment delivering a substantially static luminous flux, this method comprising in implementation examples:
at least one sensor with pixels operating in photovoltaic mode observing the surface,
synchronizing the end of the exposure, to within a delay, with the laser pulse.

The method includes, in other implementation examples:
the observation of the surface by at least one pixel sensor operating in photovoltaic mode,
the reading of the pixels at high frequency chosen to lead to a sensor response that is substantially linear to the pulse and logarithmic with regard to the substantially static luminous flux.

Thus in case of this synchronization or the reading of the pixel at high frequency, it can lead to a response of the sensor which is substantially linear to the pulse and logarithmic with regard to the substantially static luminous flux.

By virtue of the invention, the signal-to-noise ratio of the laser spot with respect to the luminous background is improved, which makes it possible to view the spot better, including in a luminous environment.

“Substantially static” should be understood as meaning that the luminous intensity does not vary or varies little (for example, less than +/−10%) over a time tₑₓₚ which is large compared to the duration d of the laser pulse, typically with tₑₓₚ/d>10, better still 10², even better still 10³. The substantially static luminous flux corresponds, for example, to the lighting of the target surface by daylight or any continuous source.

“Substantially linear response” should be understood as meaning a signal response which is proportional to the input flux with a maximum deviation from linearity of less than 20%.

“To within a delay” should be understood as meaning that the end of the exposure is offset in time from the end of the pulse by a predefined quantity, preferably of less than or equal to 1 ms, ideally 100 μs.

In the case of synchronizing the end of the exposure with a delay to the laser pulse, the end of the exposure corresponds to the start of the process of reading the pixels for producing an image.

In one example of an implementation of the invention, the method comprises detecting the pulse using a photodetector receiving the light from the laser. One example of an embodiment of such a photodetector is a monodiode filtered on the wavelength of the laser. It is thus not necessary to establish information transmission between the laser source and the circuit. This photodetector may share or not share optical components with the sensor, for example lenses or groups of lenses which make it possible to focus the image of the scene on the sensor. Clear focusing on the photodetector is not necessary; it is enough for the field observed to be substantially the same.

In one variant implementation of the method, the latter comprises the laser transmitting a synchronization signal to the sensor. This signal is, for example, transmitted to the sensor by the laser source, or by a shared master synchronizer, for example via a wired or wireless link. This may make it possible to dispense with the aforementioned photodetector. This signal may mark the start of the pulse or its end; in the event that it marks the start of the pulse, knowing the duration of the pulse makes it possible to determine the moment when the end of the exposure should take place in order to arrive after the end of the pulse.

The duration of the laser pulse is, for example, less than or equal to 100 ns, better still between 10 and 30 ns.

The end of the exposure may take place with a delay of less than or equal to 2 milliseconds after the end of the pulse, better still of less than or equal to 1 microsecond. This delay may only be induced by the reaction time of the read electronics.

The exposure time in the absence of a laser pulse may be higher than or equal to 1 ms, particularly between 1 and 30 ms. This time may be chosen as a function, for example, of the opening of the optic, or whether the scene observed is highly reflective. One of the advantages of the invention is that the time has relatively little influence on performance.

In an example of the implementation of the process, the end of the exposure is not synchronized with the laser pulse. The image acquisition is triggered by a clock signal preferably having a frequency higher than 1 kHz.

Acquiring images at such a frequency allows for a response that is substantially linear to the pulse and logarithmic with respect to the substantially static luminous flux. The different images can be processed as a group or separately. In the case of global processing of the different images, they can be averaged, which helps to reduce noise and improve the visibility of a received point light signal.

The pixel readout mode can be of the NDRO (Non-Destructive Read Out) type of IWRHS (Integrate While Read High Speed) type. The exposure time (between two photodiode resets) can be greater than or equal to 1 ms, particularly between 1 and 60 ms, particularly between 1 and 30 ms in the case of synchronizing the end of exposure with the pulse.

Preferably, the laser pulses are repeated, notably at a frequency of more than or equal to 10 Hz and preferably of less than or equal to 20 Hz. The images may then be acquired with the sensor at a frequency which is sufficient for acquiring at least one image between two laser pulses, for example at a frequency of more than or equal to 50 Hz. This image without the spot may be subtracted from that with the spot so as to generate an image of the spot alone, or quite simply in order to see the spot blink in order to observe it better.

The method may have various applications, among which, non-exhaustively, mention may be made of the alignment between an emitter and a receiver in free-field conditions, the alignment of an emitter with any target, the analysis of the distribution of energy or of a wavefront of laser radiation, or the positioning of a laser beam on a surface on which laser beam welding should be carried out. The image of the light spot in a scene, provided with the method according to the invention, may also be used to guide, for example, a tool or an object, such as a parcel, towards an objective designated by this spot, for example with a view to a parcel being dropped by a drone.

Another subject of the invention, according to another of its aspects, is a system for detecting a light spot formed by a laser pulse from a laser source in a scene delivering a substantially static luminous flux, notably for implementing the aforementioned method, this system comprising:
at least one sensor with pixels operating in photovoltaic mode,
a circuit for synchronizing the end of the exposure of the sensor, to within a delay, with the laser pulse, or a pixel readout circuit at a high acquisition frequency, the synchronization circuit or the acquisition frequency leading to a response of the sensor which is substantially linear to the pulse and logarithmic with regard to the static flux from the scene.

The system may comprise a photodetector which is able to receive the light from the laser, the synchronization circuit triggering, to within said delay, the end of the exposure in the event that the laser pulse is detected by the photodetector. In one variant, the system comprises an input which makes it possible for the synchronization circuit to receive a synchronization signal giving notice of the emission of the pulse by the illuminator.

The synchronization circuit may be arranged so that the end of the exposure takes place with a delay of less than or equal to 2 milliseconds after the end of the pulse, better still of less than or equal to 1 microsecond.

The exposure time in the absence of a laser pulse may be between 1 and 30 ms.

Another subject of the invention is an assembly comprising the laser source and the detection system according to the invention. The illuminator may in particular be configured to emit the pulses repeatedly, notably at a frequency of more than or equal to 10 Hz and preferably of less than or equal to 20 Hz.

The sensor may be arranged to acquire the images at a frequency which is more than that at which the pulses are emitted. This makes it possible to acquire images without the spot linked to the pulse, which may serve as reference images for being subtracted from the image of the scene with the spot, and make it possible to view the spot alone, or to display a blinking of the spot in order to view it better.

### BRIEF DESCRIPTION OF THE DRAWINGS

The invention may be understood better on reading the following detailed description of non-limiting examples of implementations thereof, and on examining the appended drawing, in which:

FIG. 1 schematically depicts one example of an assembly according to the invention,

FIG. 2 is a view, which is analogous to FIG. 1, of one variant assembly,

FIG. 3 schematically depicts one example of a pixel architecture of a sensor according to the invention,

FIG. 4 illustrates, by analogy with the filling of a tank, the behaviour of a logarithmic-response pixel when faced with an incident light flux,

FIG. 5 illustrates the response of the pixel as a function of exposure time,

FIG. 6 is a view, which is analogous to FIG. 4, illustrating the effect of a light pulse,

FIG. 7 depicts the response of the pixel to the light pulse,

FIG. 8 illustrates the reduction of the exposure time after the end of the pulse is detected,

FIG. 9 depicts the decrease of the signal from the pixel after the end of the pulse,

FIG. 10 illustrates the signal seen by the pixels in the presence and in the absence of laser illumination, and

FIG. 11 depicts the image of the spot after subtraction of the signal corresponding to the static flux from the scene.

FIG. 12 schematically represents an example of a pixel architecture of a sensor according to the invention.

FIG. 13 schematically illustrates the operation of a sensor according to an implementation of the invention involving synchronization between the end of the pulse and the end of the exposure.

FIG. 14 schematically illustrates the operation of a sensor according to an implementation of the invention, without synchronization between the end of the pulse and the end of the exposure.

### DETAILED DESCRIPTION

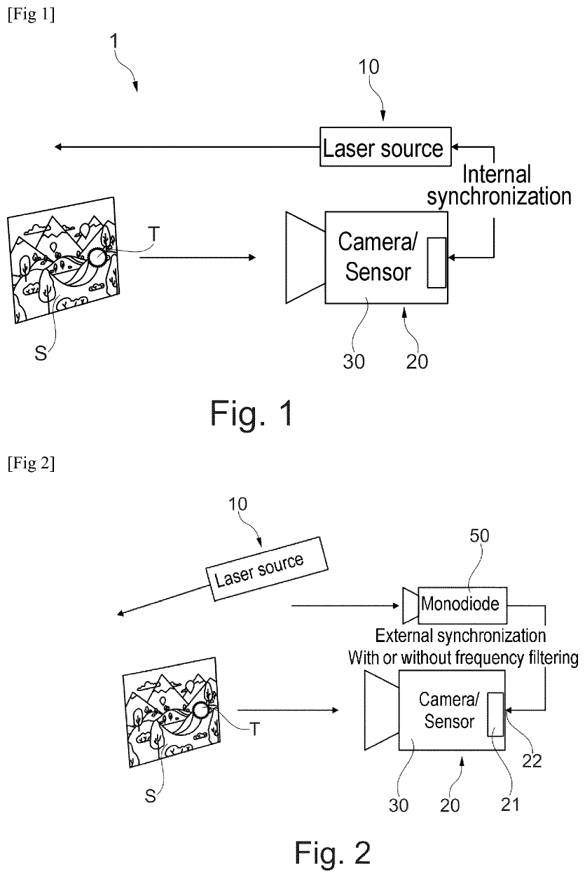

FIG. 1 illustrates one example of an assembly 1 according to the invention, comprising a laser source 10 and a detection system 20 making it possible to image a scene S in which the spot T projected by the laser source 10 is present.

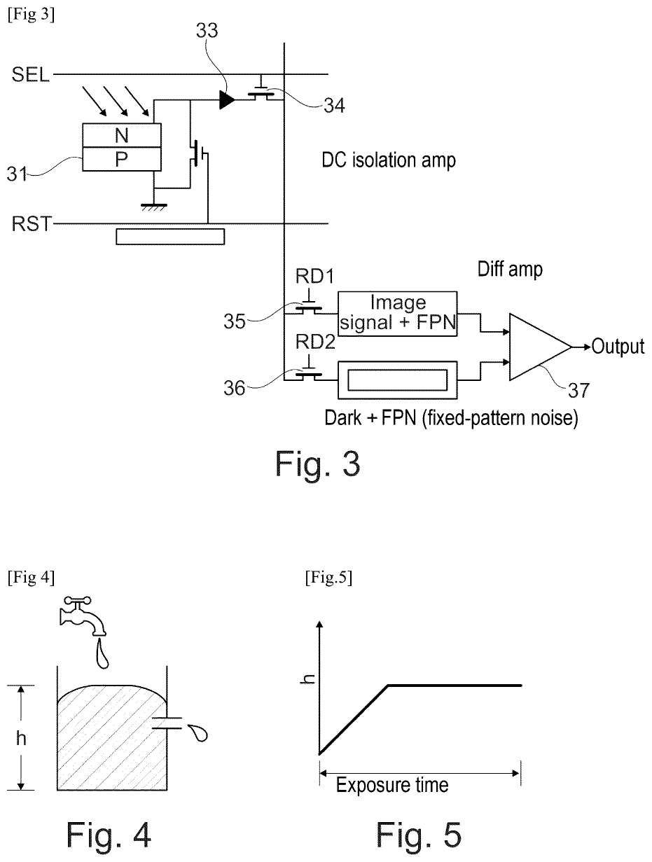

The detection system 20 comprises an optical sensor 30 which comprises logarithmic-response pixels, for example such as that depicted schematically and partially in FIG. 3.

### Laser Source

The laser source 10 may emit in any wavelength range which is compatible with it being viewed by the detection system, for example in the visible or non-visible region, notably in the infrared, in particular in the SWIR band ranging from 900 nm to 2500 nm.

The source emits laser pulses the duration of which is preferably less than or equal to 30 ns, better still between 1 and 30 ns, notably between 10 and 20 ns.

The source may comprise any type of laser, for example solid-state or gas.

In the example of FIG. 1, the laser source transmits a synchronization signal to the detection system 20 via a link 40, which is, for example, wired.

This signal makes it possible to inform the detection system 20 of the moment when the pulse begins to be emitted or finishes being emitted.

In the variant of FIG. 2, the link 40 does not exist, and the detection system 20 comprises additional means 50 making it possible to detect the light spot from the laser pulse independently of the optical sensor 30. These means 50 comprise, for example, a photodetector such as a photodiode, which is sensitive to the light from the laser and preferably equipped with a band-pass filter centred on the wavelength of the laser and rejecting other wavelengths. This photodetector sends its output signal to an input 22 of a synchronization circuit 21 of the detection system 20, which controls the instant at which the pixels of the sensor 30 are read.

Referring to FIG. 3, it can be seen that each pixel of the sensor 30 operates in photovoltaic mode, with a forward-biased photodiode junction 31, a short-circuit transistor 32 which is turned on before each measurement, and a read amplifier 33. The sensor also comprises pixel selection transistors 34 and others 35 and 36 making it possible to read differentially, with a differential amplifier 37, in the absence of a signal (i.e. the pixel is totally in the dark) and in the presence of the signal. The storage capacitors are not depicted in this figure, the architecture of a pixel of this type being known, notably from the patent applications mentioned in the introduction of the patent application.

This pixel architecture has the advantage of not saturating before a large flux by compressing the “static” flux originating from the scene. In contrast, this structure has the advantage of responding linearly to a pulse response, before seeing the response return gradually to the compressed response of the static flux.

In accordance with implementation examples of the invention, the laser feedback instant is known, either because the detection system is synchronized with the laser source as in FIG. 1 or because an additional detector 50 is used as in FIG. 2.

The advantage of the logarithmic sensor is then exploited in order for the end of the exposure period to coincide, with a predetermined delay, for example of the order of 1 μs, with the end of the pulse in the image.

Thus, with a longer exposure time, for example of the order of 5 to 20 ms, the signal from the scene is compressed, but the signal from the laser is not, which makes it possible for there to be a signal-to-noise ratio of the laser spot with respect to the background which is relatively high, as will be explained below.

The accumulation of charge linked to the incident light within a pixel of the sensor is in some ways analogous to the filling of a tank with water, as illustrated in FIG. 4.

In order to get the analogy with a pixel the logarithmic response of which rests on using a photodiode in photovoltaic mode, that is to say that the accumulation of charge develops logarithmically past a given threshold, it may be considered that the tank has a lateral overflow drainage opening, creating an outflow at quite a low height, corresponding to said threshold.

The tap corresponds, in FIG. 4, to the photon flux, which is considered to be constant for a given exposure time. The water level reaches a certain height h in the tank, which depends on the flowrate of water flowing out of the tap. This level no longer changes after a certain time, as illustrated in FIG. 5, because of the presence of the overflow.

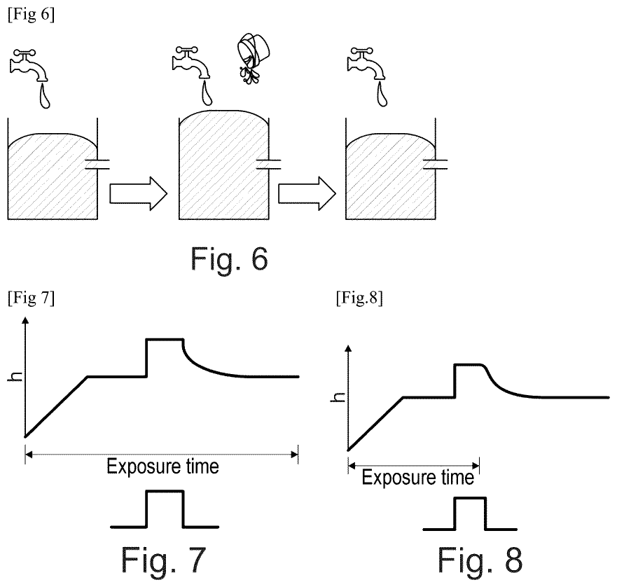

The effect of the laser pulse may be seen as the pouring of a bucket of water into the tank, as illustrated in FIG. 6. This pouring causes a momentaneous increase of the level in the tank, before the water flows out via the lateral opening in order to return to the level preceding the pouring of the bucket, as illustrated in FIG. 7.

The more luminous the environment, the larger the photon flux, and by analogy the smaller the amount contributed by the bucket compared to that contributed by the tap during the measurement period (corresponding by analogy to the exposure time).

With a sensor with conventional pixels of the CTIA type, the tank does not have the overflow and the total amount of water is measured at the end of the measurement period. If the tap has a high flowrate, the volume of the bucket remains small with respect to the total amount of water accumulated. In other words, the charge linked to the laser pulse is small with respect to the total amount of charge accumulated. In addition, it is not possible to wait too long for the arrival of the pulse, since the tank continues to fill in the absence of a lateral drainage opening.

With a logarithmic sensor the pixel of which operates in photovoltaic cell mode, the voltage at the end of the exposure period, or by analogy the level in the tank, not the total amount of water accumulated, is measured.

In a pixel of this type, the charge is emptied at the start of the exposure by actuating the short-circuit transistor then, at the end of the exposure, the voltage is measured, or by analogy the tank is empty at the start of the exposure and, at the end of the exposure, the height in the tank is measured.

The logarithmic-response pixels may be exposed to the scene to be observed a long time in advance, since they do not fear saturation. Thus, in a logarithmic pixel, the moment of the end of the exposure does not make a difference in the presence of a constant photon flux but, in the event of a momentaneous contribution, the level increases before returning to the equilibrium level. This momentaneous increase is exploited in order to carry out the measurement. It can be seen in FIG. 7 that, if the exposure continues for too long after the end of the pulse, the pixel has the time to return to its equilibrium level.

In accordance with implementation examples of the invention, the pixel is read, i.e. an end is put to the exposure, early enough after the end of the pulse for the pixel not to have had the time to return to its equilibrium state, as illustrated in FIG. 8.

In this case, the voltage read does indeed include the increase linked to the pulse, and the signal-to-noise ratio is improved.

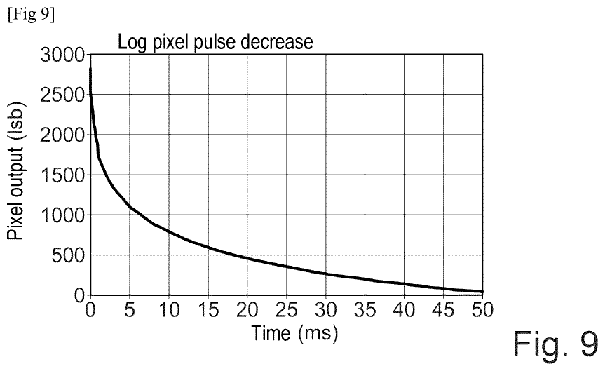

As illustrated in FIG. 9, for one typical example of a logarithmic-response pixel, the decrease is significant starting from 100 μs.

The pixel will therefore preferably be read with a delay of less than 100 μs after the end of the pulse. The start of the exposure period may take place well before the arrival of the laser pulse, without fear of missing it. Regardless of the start of the exposure time, the pixel is not saturated. This is not possible with a standard pixel of the CTIA type, which is completely saturated if the exposure time becomes too long.

Another advantageous aspect of the behaviour of the logarithmic-response pixel is that the response when faced with a pulse is not symmetrical, that is to say that the increase is very rapid while the decrease occurs more slowly. This means that the pixel will generally have a complete increase of its output signal almost instantaneously on the arrival of the pulse, and will have a decrease which is slow enough to make measurement possible.

The invention makes it possible to view the spot linked to the laser pulse and the scene having received the pulse in the same image, and the image of the spot is not a binary representation thereof but an image comprising the information on the luminous intensity in each pixel of the spot, notably linked to the distribution of the light energy within the laser beam.

The invention may also make it possible to avoid the problems with the efficiency of the resetting of the photodiodes encountered with sensors of CTIA type in certain situations.

The decrease speed in FIG. 9 may be adjusted by exploiting the bias of the photodiode, which makes it possible to optimize the decrease rate and to improve the response. The decrease speed may be adjusted as a function of the response time to the pulse which is necessary.

In one variant, images of the scene without the spot and images with it are acquired by illuminating the scene at a frequency which is less than that at which the images are acquired.

For example, the frequency of the laser pulses is between 10 and 20 Hz, and acquisition is carried out at a frequency of more than or equal to 50 Hz.

By comparing the images taken with the spot and those taken without the spot, the perception of the latter may be improved. The spot may also be made to “blink” in order to view it better for an operator.

In other implementation examples of the invention, the acquisition is done in a non-destructive readout (NDRO) mode or IWR mode at a sufficiently high frequency so that the sensor's response to the pulse is linear and logarithmic with respect to the static luminous flux.

In this case, the synchronization described above is no longer necessary.

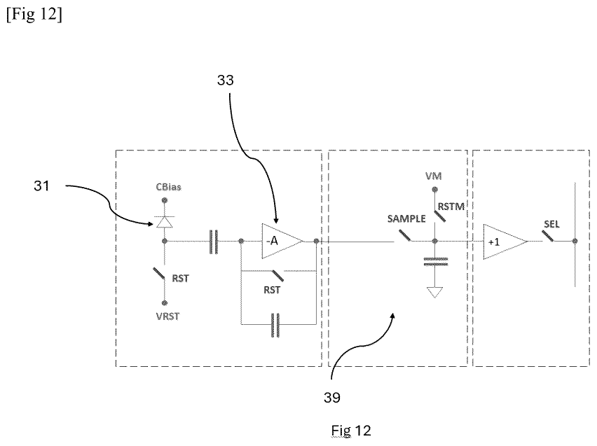

FIG. 12 shows an example of a sensor with a logarithmic response, schematically illustrating different electronic switches whose state changes govern the sensor's operation. The left block corresponds to detection and uses a forward-biased photodiode 31, as is known in itself. The center block includes a capacitor that stores the charge and schematically represents the storage of the detected signal. The right block schematically represents the readout. The RST switch allows the photodiode to be reset as explained above. The SAMPLE switch, when on, activates the capacitor's charge and records the signal detected by the photodiode 31. The RSTM switch, when on, resets the charge in the capacitor. The SEL switch, when on, allows the charge to be read.

The SEL switch is configured to turn on when the SAMPLE switch turns off.

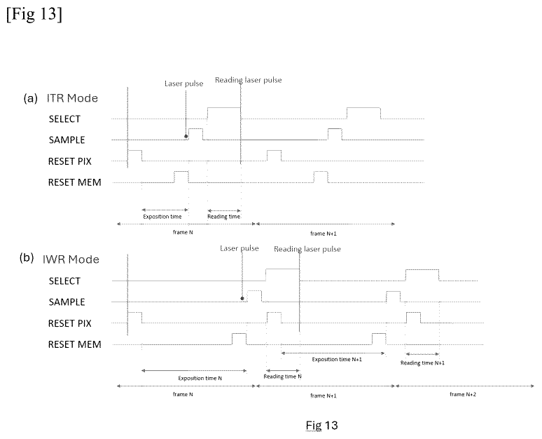

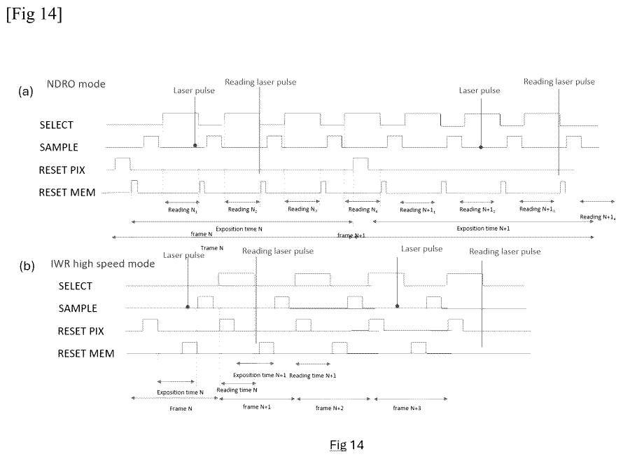

In the timing diagrams of FIGS. 13 and 14, each rising edge corresponds to the switch turning on, and each falling edge corresponds to the switch turning off.

In the previously described examples, the end of the pixel exposure time is synchronized with the pulse.

FIG. 13 shows two timing diagrams illustrating the operation of a sensor with synchronization of the end of the sensor's exposure with the pulse. The time scales of the different signals are not necessarily respected for clarity.

In FIG. 13(a), the sensor operates in a mode called ITR (Integrate Then Read), in which a frame N consists of the exposure time followed by the readout time. The integration of the photodiode signal by the capacitor (SAMPLE high) occurs just after the pulse, and then the result is read (SELECT high) before resetting the photodiode.

In FIG. 13(b), the sensor operates in IWR (Integrate While Read) mode, in which the readout of the signal received in frame N occurs during frame N+1, and the acquisition of the next signal occurs after resetting the pixel.

When the end of the pixel exposure time is not synchronized with the pulse, a clock signal allows the acquisition of signals at defined time intervals, at a sufficiently high frequency as indicated above so that the readout can occur while the sensor has still a linear response to the pulse.

FIG. 14 shows two timing diagrams illustrating the operation of a sensor without synchronization of the end of the sensor's exposure with the pulse. The time scales of the different signals are not necessarily respected for clarity.

In FIG. 14(a), the sensor operates with the memory cell in a non-destructive readout mode called NDRO. This operating mode allows multiple signals to be acquired and read for a single pixel exposure time.

Following the start of the exposure (falling edge of RESET PIX), repeated reading of the signal is performed (SAMPLE high), for example, at a frequency defined by a clock signal. An acquisition occurs in the interval between two high states of SAMPLE. The readout of each acquired signal occurs during the next acquisition. Thus, the laser pulse is detected during the acquisition concurrent with the N1 readout interval, and its readout occurs during the next N2 readout interval.

In FIG. 14(b), the IWR mode described in FIG. 13(b) is used at high frequency without synchronization. After each time defined by the clock signal, an acquisition is performed (interval between the falling edge of RESET PIX and the rising edge of SAMPLE), followed by a pixel reset, leading to a new frame and a new acquisition. The readout of the signal acquired in frame N occurs during the next frame N+1. In this case, the pulse is detected in frame N during the corresponding exposure time and read during the next exposure time.

### EXAMPLE

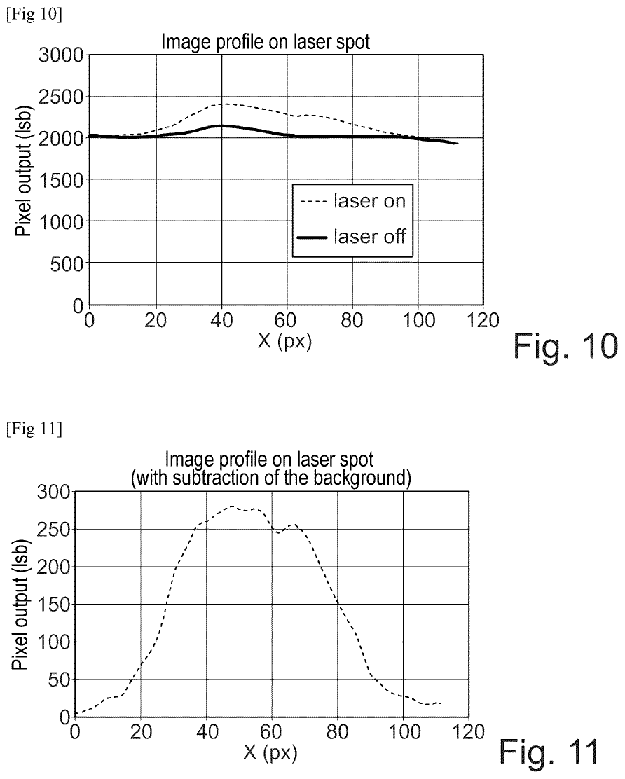

FIG. 10 depicts one example of a response of a sensor according to the invention to a scene lit with a laser illuminator in broad daylight.

FIG. 11 illustrates the subtraction, from the overall signal, of the signal corresponding to the constant luminous flux from the scene; the spot image, and notably the spatial distribution of the luminous intensity of the spot, can be seen with a higher intensity at the centre thereof.

1. A method for detecting a light spot formed by a laser pulse delivered by a laser source on a target surface, the target surface being situated in an environment delivering a substantially static luminous flux, this method comprising:
at least one sensor with pixels operating in photovoltaic mode observing the surface, and
either synchronizing the end of the exposure, to within a delay, with the laser pulse, the exposure time in the absence of a laser pulse being higher than or equal to 1 ms,
or acquiring images at a high frequency,
wherein the synchronization or high-frequency readout leading to a response of the sensor which is substantially linear to the pulse and logarithmic with regard to the substantially static luminous flux, said frequency being chosen to obtain said response.

2. The method according to claim 1, further comprising synchronizing the end of the exposure, with a delay, with the laser pulse, leading to a sensor response that is substantially linear to the pulse and logarithmic with respect to the substantially static light flux, the exposure duration being preferably between 1 and 30 ms.

3. The method according to claim 1, further comprising acquiring images at a high frequency leading to a sensor response that is substantially linear to the pulse and logarithmic with respect to the substantially static light flux.

4. The method according to claim 1, further comprising detecting the pulse using a photodetector receiving the light from the laser.

5. The method according to claim 1, further comprising transmitting a synchronization signal to the sensor.

6. The method according to claim 1, wherein the duration of the laser pulse being less than or equal to 30 ns.

7. The method according to claim 1, the end of the exposure taking place with a delay of less than or equal to 2 milliseconds after the end of the pulse.

8. The method according to claim 1, wherein the pulse being repeated.

9. The method according to claim 1, wherein images are acquired with the sensor at a frequency which is sufficient for acquiring at least one image between two laser pulses.

10. The method according to claim 3, wherein the pixel readout is performed in NDRO or IWR mode.

11. A system for detecting a light spot formed by a laser pulse from a laser source in a scene delivering a substantially static luminous flux, comprising
at least one sensor with pixels operating in photovoltaic mode, and
a circuit for synchronizing the end of the exposure of the sensor, to within a delay, with the laser pulse,
wherein the exposure duration being greater than or equal to 1 ms, or a pixel readout circuit at a high acquisition frequency, the synchronization circuit or the acquisition frequency leading to a response of the sensor which is substantially linear to the pulse and logarithmic with regard to the static flux from the scene.

12. The system according to claim 11, further comprising a photodetector which is able to receive the light from the laser, the synchronization circuit triggering, to within said delay, the end of the exposure in the event that the laser pulse is detected by the photodetector.

13. The system according to claim 11, further comprising an input which makes it possible for the synchronization circuit to receive a synchronization signal giving notice of the emission of the pulse by the source.

14. The system according to claim 11, wherein the synchronization circuit being arranged so that the end of the exposure takes place with a delay of less than or equal to 2 milliseconds after the end of pulse.

15. The system according to claim 11, wherein the exposure time in the absence of a laser pulse being between 1 and 30 ms.

16. An assembly comprising a laser source and the detection system according to claim 11.

17. The assembly according to claim 16, wherein the laser source being configured to emit a pulse repeatedly.

18. The assembly according to claim 17, wherein the sensor being arranged to acquire images at a frequency which is more than that at which the pulses are emitted.

19. The assembly according to claim 16, the duration of the laser pulse being less than or equal to 100 ns.
